(19) United States
(12) Patent Application Publication
(10) Pub. No.: US 2010/0055601 A1
(43) Pub. Date: Mar. 4, 2010

(54) RESIN-FILLED CARRIER FOR ELECTROPHOTOGRAPHIC DEVELOPER AND ELECTROPHOTOGRAPHIC DEVELOPER USING THE RESIN-FILLED CARRIER

(75) Inventors: Takao SUGIURA, Kashiwa-shi (JP); Takashi HIKICHI, Matsudo-shi (JP); Hiromichi KOBAYASHI, Nagareyama-shi (JP)

Correspondence Address: GREENBLUM & BERNSTEIN, P.L.C., 1950 ROLAND CLARKE PLACE, RESTON, VA, 20191, US

(73) Assignee: POWDERTECH CO., LTD., Chiba (JP)

(21) Appl. No.: 12/542,915

(22) Filed: Aug. 18, 2009

(30) Foreign Application Priority Data
Aug. 29, 2008 (JP) 2008-222457

(51) Int. Cl. G03G 9/107

(52) U.S. Cl. 430/111.31

(57) ABSTRACT

A resin-filled carrier for an electrophotographic developer which carrier is obtained by filling a resin in the voids of a porous ferrite core material, wherein the Cl concentration of the porous ferrite core material, measured by an elution method, is 10 to 280 ppm and the resin contains an amine compound, and an electrophotographic developer using the resin-filled carrier.

### BACKGROUND OF THE INVENTION

1. Field of the Invention

The present invention relates to a resin-filled carrier used in a two-component electrophotographic developer used in copiers, printers and the like. More specifically, the present invention relates to a resin-filled carrier for an electrophotographic developer, capable of obtaining an intended charge amount and small in the environmental variation of the charge amount, and an electrophotographic developer using the resin-filled carrier.

2. Description of the Related Art

An electrophotographic development method conducts development by adhering toner particles in a developer to an electrostatic latent image formed on a photoreceptor. The developers used in such a method are classified into two-component developers composed of toner particles and carrier particles and one-component developers using only toner particles.

As the development methods using two-component developers composed of toner particles and carrier particles among such developers, a cascade method and the like have long been adopted; currently, however, magnetic brush methods using a magnet roll are predominant.

In a two-component developer, the carrier particles serve as a carrying substance to form a toner image on the photoreceptor in such a way that the carrier particles are stirred together with the toner particles in a developer box filled with the developer to impart a desired charge to the toner particles, and further, convey the thus charged toner particles to the surface of the photoreceptor to form the toner image on the photoreceptor. The carrier particles remaining on a development roll which holds a magnet again return from the development roll to the developer box to be mixed and stirred with the fresh toner particles to be repeatedly used for a predetermined period of time.

In contrast to a one-component developer, a two-component developer is such that the carrier particles are mixed and stirred with the toner particles, thus charge the toner particles, and further have a function to convey the toner particles, and a two-component developer is excellent in the controllability in designing developers. Accordingly, two-component developers are suitable for apparatuses such as full-color development apparatuses required to offer high image quality and high-speed printing apparatuses required to be satisfactory in the reliability and durability in image maintenance.

In two-component developers used in the above-described manner, the image properties such as the image density, fogging, white spot, gradation and resolution are each required to exhibit a predetermined value from the initial stage, and further these properties are required to be invariant and to be stably maintained during the endurance printing. For the purpose of stably maintaining these properties, the properties of the carrier particles contained in the two-component developers are required to be stable.

As the carrier particles which form two-component developers, there have hitherto been used various carriers such as iron powder carriers, ferrite carriers, resin-coated ferrite carriers and magnetic powder-dispersed resin carriers.

Recently office networking has been promoted, and the age of monofunctional copiers develops into the age of multifunctional copiers; the service system has also shifted from the age of the system such that a contracted service man conducts periodic maintenance inclusive of the replacement of the developer to the age of the maintenance-free system; thus, the market has further enhanced demand for further longer operating life of the developer.

Under such circumstances, for the purpose of reducing the carrier particle weight and extending the developer operating life, Japanese Patent Laid-Open No. 5-40367 and the like have proposed a variety of magnetic powder-dispersed carriers in each of which magnetic fine particle are dispersed in a resin.

Such magnetic powder-dispersed carriers can be reduced in true specific gravity by decreasing the amounts of the magnetic fine particles and can be alleviated in stress caused by stirring, and hence can be prevented from the abrasion and exfoliation of the coating film and accordingly can offer stable image properties over a long period of time.

However, the magnetic powder-dispersed carrier is high in carrier resistance because the magnetic fine particles are covered with a binder resin. Consequently, the magnetic powder-dispersed carrier offers a problem that a sufficient image density is hardly obtained.

The magnetic powder-dispersed carrier is prepared by agglomerating magnetic fine particles with a binder resin, and hence offers, as the case may be, a problem that the magnetic fine particles are detached due to the stirring stress or the impact in the developing device or a problem that the carrier particles themselves are cracked probably because the magnetic powder-dispersed carriers are inferior in mechanical strength to the iron powder carriers and ferrite carriers having hitherto been used. The detached magnetic fine particles and the cracked carrier particles adhere to the photoreceptor to cause image defects as the case may be.

Additionally, the magnetic powder-dispersed carrier uses magnetic fine particles, and accordingly has a drawback that the residual magnetization and the coercive force are high and the fluidity of the developer is degraded. In particular, when a magnetic brush is formed on a magnet roll, the presence of the residual magnetization and the coercive force hardens the ears of the magnetic brush and hence high image quality is hardly obtained. Additionally, even when the magnetic powder-dispersed carrier is separated away from the magnet roll, the magnetic coagulation of the carrier is not unstiffened and the mixing of the carrier with the supplied toner is not rapidly conducted, and hence there occurs a problem that the charge amount rise is aggravated, and image defects such as toner scattering and fogging are caused.

As a substitute for the magnetic powder-dispersed carrier, there has been proposed a resin-filled carrier in which the voids in a porous carrier core material are filled with a resin. For example, Japanese Patent Laid-Open No. 11-295933 describes a carrier including a soft magnetic core, a polymer contained in the pores of the core and the coating that covers the core. These resin-filled carriers are described to provide carriers that are small in impact, have an intended fluidity, are wide in triboelectric charge value range, have an intended conductivity and have a volume average particle size falling within a certain range.

In this connection, Japanese Patent Laid-Open No. 11-295933 describes that, as core materials, various appropriate porous solid core carrier substances such as known porous cores can be used. It is described to be particularly important that the core material is porous and has an intended fluidity, quoting as noteworthy properties soft magnetism, the porosity represented by the BET area and the volume average particle size.

With the porosity of about 1600 cm²/g in terms of the BET area as described in the example of Japanese Patent Laid-Open No. 11-295933, however, no sufficiently low specific gravity is attained even by resin filling, and it has been found that the recent increasingly enhanced demand for the longer operating life of the developer is not fulfilled.

Further, as described in Japanese Patent Laid-Open No. 11-295933, by just a simple control of the porosity represented by the BET area, it is difficult to control with a satisfactory accuracy the specific gravity and the mechanical strength of the carrier after having been filled with a resin.

The measurement principles of the BET area are such that the physical adsorption and the chemical adsorption of a specific gas are measured and are not correlated with the porosity of a core material. In other words, when the core material has almost no pores, the BET area of the core material is generally varied depending on the particle size, the particle size distribution, the surface material and the like. Even when the porosity is controlled by the BET area measured in such a way, the core material cannot be said to be a core material permitting a sufficient filling of a resin. When a large amount of a resin is attempted to be filled in a core material that is high in the numerical value of the BET area but is not porous or is not sufficiently porous, it is difficult to obtain stable properties in such a way that the resin remaining unfilled is present in an isolated manner without being in contact with the core material to float in the carrier, the aggregation between the particles occurs in a large amount to degrade the fluidity, and the charging property is largely varied when such an aggregation is disintegrated during an actual operation period.

Additionally, Japanese Patent Laid-Open No. 11-295933 describes that a porous core is used, and the total content of the resin filling the pores of the core and the resin coating the surface of the core is preferably about 0.5 to about 10% by weight of the amount of the carrier. Further, in the example of Japanese Patent Laid-Open No. 11-295933, the content of such resins is at most less than 6% by weight in relation to the carrier. Such a small amount of resin cannot realize the intended low specific gravity, and can attain only the same performances as those of the resin-coated carriers having hitherto been used.

Additionally, Japanese Patent Laid-Open No. 54-78137 discloses a carrier for an electrostatic image developer in which carrier a fine powder of an electrical insulating resin is filled in the pores of magnetic particles and the recessed portions on the magnetic particle surface wherein the magnetic particles are substantially smaller in bulk specific gravity than nonporous particles and are porous or large in surface roughness.

Japanese Patent Laid-Open No. 2006-337579 proposes a resin-filled carrier prepared by filling a resin in a ferrite core material having a porosity of 10 to 60%, and Japanese Patent Laid-Open No. 2007-57943 proposes a resin-filled carrier having a three-dimensional laminated structure. Japanese Patent Laid-Open Nos. 2006-337579 and 2007-57943 disclose that: various methods are usable as the method for filling a resin in a core material for a resin-filled carrier; examples of such a method include a dry method, a spray drying method based on a fluidized bed, a rotary drying method and a dipping-and-drying method using a universal stirrer or the like; and these methods are appropriately selected according to the core material and the resin to be used.

The porous magnetic powders described in these Japanese Patent Laid-Open Nos. 2006-337579 and 2007-57943 include examples in which the pore volume of the core material is examined on the basis of the BET specific surface area or the oil absorption amount. However, the BET specific surface area is a surface area in itself, and the value thereof does not directly determine the actual porosity. Although the oil absorption amount reflects the pore volume to some extent, the oil absorption simultaneously measures the space between the particles as can be seen from the measurement principles thereof and hence does not lead to the actual pore volume. In general, the space between the particles is larger than the actual pore volume in the particles, and hence the oil absorption is insufficient in accuracy as an index for the purpose of filling a resin without extreme excess or deficiency. Additionally, these Japanese Patent Laid-Open Nos. 2006-337579 and 2007-57943 do not include any description on the size of the pores located on the ferrite surface and filled with a resin and on the distribution of the pore size, and consequently, when a resin is actually filled, the filled resin amount varies among the particles or an insufficient uniformity of the filled resin is resulted. Consequently, the particles insufficiently filled with the resin are low in strength, and when the carrier is used in an actual machine, the cracking of the carrier particles occurs and fine particles are generated from the carrier particles to offer a cause for image defects.

Japanese Patent Laid-Open No. 2007-218955 describes the pore size, pore volume and the like of the particles of a core material. Specifically, Japanese Patent Laid-Open No. 2007-218955 discloses that: the provision of a carrier core material, at a stage of the carrier core material before the resin coating, with the durability enabling to maintain a high resistance under the conditions of high voltage application remarkably improves the maintenance of the high resistance under the conditions of high voltage application at the time of being used as an electrophotographic developer, and enables to prevent the breakdown and the degradation of the image properties; additionally, with respect to the spent resistance, it is important to obtain a carrier core material by forming a porous magnetic powder having a specific pore distribution property and by subjecting the porous magnetic powder to a treatment for providing the powder with a high resistance.

However, it has already been revealed that unless both of the pore distribution property and the electric resistance of the carrier core material are satisfactory, no intended properties can be obtained as shown by Comparative Example 4 in Japanese Patent Laid-Open No. 2007-218955.

This means that the pore distribution property as described in Japanese Patent Laid-Open No. 2007-218955 is not sufficient, and demanded is a carrier core material in which a more preferable pore distribution property is more accurately controlled.

Japanese Patent Laid-Open No. 2004-77568 discloses a carrier for an electrophotographic developer which is a resin-coated carrier for an electrophotographic developer having a resin coating layer formed on the surface of a carrier core material, wherein on the surface and in the inner voids of a porous magnetic material having a weight average particle size of 20 to 45 μm, the carrier has a substance having a resistance higher than the resistance of the porous magnetic material itself and the resistance LogR of the carrier at an applied voltage of 5000 volts is 10.0 Ω·cm or more.

In Example 3 of Japanese Patent Laid-Open No. 2004-77568, shown is an example in which a step of spray drying of a mixture prepared by mixing 5 kg of a core material, 150 g of methyl methacrylate and 5 kg of toluene was repeated twice, and thereafter, a coating film of about 0.5 μm in thickness was formed with a silicone resin. In other words, the carrier disclosed in Japanese Patent Laid-Open No. 2004-77568 was prepared by subjecting the particles of a porous magnetic material to a resin treatment in an amount of at most 6% by weight. With such an amount of a resin, it is difficult to attain a low specific gravity, the stabilization of the charging property and the realization of a long operating life.

Japanese Patent Laid-Open No. 2004-77568 discloses that for the purpose of increasing the resistance of the carrier, on the surface and in the inner void portions of a porous magnetic material, resin fine particles or hard fine particles obtained by various polymerization methods are used singly or in a form of a resin containing resin fine particles therein.

As specific examples of the above-presented description, as described in the carrier production examples 7 and 8 in Japanese Patent Laid-Open No. 2004-77568, fine particles were made to adhere to the recessed portions located on the surface of a core material but fine particles were not filled in the interior of a porous core material. Additionally, such presence of fine particles between the surface of a porous core material and the resin coating film results in easy exfoliation of the resin coating due to the mechanical stress at the time of actual application of the carrier. Accordingly, it has been found that the carrier functions as a high-resistance carrier in the early stages, but makes it difficult to attain stable properties over a long period of time.

Japanese Patent Laid-Open Nos. 2005-352473 and 2007-133100 disclose that conductivity-controlling particles or charging property-controlling particles are contained in the resin to coat the surface of a core material. However, the carriers described in these Japanese Patent Laid-Open Nos. 2005-352473 and 2007-133100 contains the fine particles strictly in the coating resin on the surface of the carrier but the fine particles are not filled in the interior of the porous core material.

As described above, the carriers disclosed in the above-presented respective patent publications are not based on the carrier core materials in which the preferable pore distribution property is controlled with a satisfactory accuracy, and hence, the carriers concerned are low in specific gravity as the whole carrier but undergo a specific gravity variation among particles, and consequently cannot result in carriers which are more stable and lower in specific gravity. In such carriers, the stress at the time of actual application significantly affects the carrier properties, in particular, the stability of the charge amount, and the intended charge amount is not obtained and the variation of the charge amount over a long period of time is not small.

On the other hand, Japanese Patent Laid-Open No. 52-56536 describes a humidity-insensible ferrite electron carrier substance in which the surface sodium amount and the surface zinc amount are specified and a production method of the concerned carrier substance. In Japanese Patent Laid-Open No. 52-56536, as the main reasons for the poor performances at high humidity of conventional ferrite substances in electrophotographic apparatuses, discovered was the presence of certain substances on the surface of the ferrite particles in which the surface conductivity and dielectric loss had been changed and the charge decay of the developer mixture had also been changed; such substances were assumed as the surface sodium, zinc oxide, calcium, potassium and the like bonded to sulfates; and on the basis of this discovery, the surface sodium amount and the surface zinc amount were specified as described above.

However, the invention described in Japanese Patent Laid-Open No. 52-56536 specifies the surface sodium amount and the surface zinc amount, but does not specify the chlorine amount in contrast to the below-described present invention, and does not give any description on the filling of a resin in a porous core material.

Japanese Patent Laid-Open No. 2006-267345 describes a two-component developer using a carrier which has a coating layer on a ferrite particle and contains a certain amount of the chlorine element in relation to the iron element. Japanese Patent Laid-Open No. 2006-267345 pays attention to the presence of the trace elements contained in the carrier and the effects thereof, and in particular, pays attention to the fact that the chlorine element in the ferrite particle affects the durability of the carrier, and shows that: the control of the amount of the chlorine element improves the hardness of the ferrite and develops a tough durability in the ferrite so as for the ferrite not to be chipped even when a load is applied; the polar effect of the chlorine element improves the adhesion between the ferrite surface and the resin coating layer, and consequently the resin coating layer is not easily exfoliated.

Japanese Patent Laid-Open No. 2006-267345 describes the presence of the chlorine element, but does not describe anything about the fact that the presence of chlorine affects the charge amount and about the filling of a resin in a porous core material.

As described above, there has been demanded a resin-filled carrier for an electrophotographic developer capable of obtaining an intended charge amount and additionally small in the charge amount variation over a long period of time while the above-described advantages of the resin-filled carrier are being maintained.

### SUMMARY OF THE INVENTION

Under the above-described circumstances, an object of the present invention is to provide a resin-filled carrier for an electrophotographic developer capable of obtaining an intended charge amount and additionally small in the environmental variation of the charge amount while the advantages of the resin-filled carrier are being maintained, and an electrophotographic developer using the resin-filled carrier.

For the purpose of solving the above-described problems, the present inventors conducted a diligent study and consequently reached the present invention by discovering that the above-described object can be achieved by controlling the Cl concentration of a porous ferrite core material so as to fall within a certain range and additionally by including an amine compound in a filling resin.

Specifically the present invention provides a resin-filled carrier for an electrophotographic developer which carrier is obtained by filling a resin in the voids of a porous ferrite core material, wherein the Cl concentration of the porous ferrite core material, measured by an elution method, is 10 to 280 ppm; and the resin contains an amine compound.

In the resin-filled carrier for an electrophotographic developer according to the present invention, preferably the amine compound is an aminosilane coupling agent.

In the resin-filled carrier for an electrophotographic developer according to the present invention, preferably the resin is a silicone resin.

In the resin-filled carrier for an electrophotographic developer according to the present invention, preferably the pore volume and the peak pore size of the porous ferrite core material are 0.04 to 0.16 ml/g and 0.3 to 2.0 μm, respectively.

In the resin-filled carrier for an electrophotographic developer according to the present invention, preferably the filling amount of the resin is to 20 parts by weight in relation to 100 parts by weight of the porous ferrite core material.

In the resin-filled carrier for an electrophotographic developer according to the present invention, preferably the composition of the porous ferrite core material contains at least one selected from Mn, Mg, Li, Ca, Sr, Cu and Zn.

In the resin-filled carrier for an electrophotographic developer according to the present invention, preferably the volume average particle size is 20 to 50 μm, the number average particle size is 15 to 45 μm, the saturation magnetization is 30 to 80 Am²/kg, the true specific gravity is 2.5 to 4.5, the apparent density is 1.0 to 2.2 g/cm³ and the content of the particles of less than 22 μm is 5% by volume or less.

In the resin-filled carrier for an electrophotographic developer according to the present invention, the properties of the porous ferrite core material are preferably as follows: the pore volume is 0.05 to 0.10 ml/g, the peak pore size is 0.4 to 1.5 μm, the Cl concentration is 10 to 280 ppm, the filling amount of the resin is 7 to 12 parts by weight in relation to 100 parts by weight of the porous ferrite core material, the volume average particle size is 30 to 40 μm, the number average particle size is 30 to 40 μm, the saturation magnetization is 50 to 70 Am²/kg, the true specific gravity is 3.5 to 4.5, the apparent density is 1.5 to 2.0 g/cm³ and the content of the particles of less than 22 μm is 3% by volume or less.

The present invention also provides electrophotographic developers each composed of any one of the above-described resin-filled carriers and of a toner.

The electrophotographic developer according to the present invention is also used as a refill developer.

The resin-filled carrier for an electrophotographic developer according to the present invention is a resin-filled ferrite carrier, hence permits attaining a low specific gravity and the weight reduction, accordingly is excellent in durability and permits attaining a long operating life, is excellent in fluidity, permits easy controlling of the charge amount and the like, is higher in strength than magnetic powder-dispersed carrier, and is free from the cracking, deformation and melting due to heat or impact. Additionally, the Cl concentration of the porous ferrite core material is controlled to fall within a certain range and the filling resin contains an amine compound, and hence an intended charge amount can be obtained and the environmental variation of the charge amount is small.

### DETAILED DESCRIPTION OF THE PREFERRED EMBODIMENTS

Hereinafter, the best mode for carrying out the present invention is described.

<Resin-Filled Carrier for an Electrophotographic Developer According to the Present Invention>

The resin-filled carrier for an electrophotographic developer according to the present invention is obtained by filling a resin in the voids of a porous ferrite core material.

In the present invention, the Cl concentration of the porous ferrite core material, measured by an elution method, is required to be 10 to 280 ppm. In the present invention, as is described below, the filling resin is made to contain an amine compound, and the amino group possessed by the amine compound has a high polarity. Although the detailed chemical reaction and the detailed chemical structure have not yet been elucidated, if a chloride or chloride ion is present on the surface of the ferrite particles in a large amount, the interaction with the amino group drastically reduces the effect of the amine compound which is originally used for the purpose of converting the polarity of the toner into a negative polarity. Accordingly, for the purpose of rendering the amine compound used able to effectively contribute to the charging property, the amount of the chloride or the chloride ion is required to be reduced as much as possible.

The chloride or the chloride ion tends to absorb the water (water molecules) located in the use environment of the carrier or the developer, and hence the presence of the chloride or the chloride ion in a large amount leads to large environmental variations of the electric properties including the charge amount.

On the other hand, as iron oxide that is a raw material for the ferrite, generally used is the iron oxide by-produced from the hydrochloric acid pickling step that occurs in the iron and steel production, and hence such iron oxide contains a chloride or chloride ion as inevitable impurities. The chloride or the chloride ion is removed for the most part when processed at high temperatures in a sintering step involved as a step in the ferrite production process, but part of the chloride or the chloride ion remains. In particular, when a porous ferrite particle is produced, the sintering temperature is required to be set at a rather low temperature, and hence the chloride or the chloride ion hardly flies apart.

The porous ferrite used for the resin-filled carrier has an extremely larger surface area as compared to the ferrite particles used for common resin-coated ferrites, and hence the remaining chloride or the remaining chloride ion significantly affects the carrier properties.

In the resin-filled carrier obtained by filling a resin in the pores possessed by a porous ferrite, it is extremely important to accurately control the properties of the porous ferrite. In particular, as compared to the ferrite particles used for common resin-coated carriers, the porous ferrite is, as a feature thereof, markedly larger in specific surface area. Accordingly, the Cl concentration in the vicinity of the surface exerts extremely significant effects.

Accordingly, as described above, in the present invention, the Cl concentration of the porous ferrite core material, measured by an elution method, is required to be 10 to 280 ppm. When the Cl concentration exceeds 280 ppm, the charging ability improvement effect due to the amine compound is degraded because the interaction with the amine compound used is strong as described above. Additionally, such a higher Cl concentration exceeding 280 ppm is not preferable because the chloride or the chloride ion tends to absorb the water (water molecules) located in the use environment and the environmental variations of the electric properties including the charge amount are thereby increased.

It is industrially difficult to make the Cl concentration lower than 10 ppm. In general, among the raw materials used in ferrites and ferrite carriers for electrophotographic developers, iron oxide is a material that contains Cl in a particularly high content. This is because generally used as iron oxide is the iron oxide by-produced industrially from the hydrochloric acid pickling step that occurs in the iron and steel production. Such iron oxide is classified into several grades, but generally any grade contains a few hundreds ppm of Cl. Even the industrially used iron oxide having the lowest Cl concentration contains about 200 ppm of Cl.

Herein, ferrite is a metal oxide represented by the following general formula (I):

(MO)ₓ(Fe₂O₃)_{y} (1)

wherein M represents a metal selected from Cu, Zn, Mn, Mg, Ni, Sn, Sr, Ca, Ba, Ti, Li and Al, MO represents one selected from or a combination of two or more selected from the oxides of these metals, and x+y=100 mol %.

For the purpose of obtaining intended magnetic properties or obtaining a ferrite that is stable in properties even during passage of time, it is preferable to satisfy the relation that y=40 mol % or more. In this case, the weight ratios involved are such that Fe₂O₃ accounts for 50% by weight or more although depending on the type of the metal oxide (MO) to be combined.

In such a ferrite that contains 50% by weight or more of Fe₂O₃, about 125 ppm of Cl is contained in the ferrite composition when there is used an iron oxide raw material that contains Cl in the industrially lowest concentration. Actually, in a calcination step or a sintering step, heating is conducted at high temperatures, and consequently Cl is partially removed, and consequently not the whole amount of Cl remains in the ferrite, in such a way at lowest about 5 ppm of Cl remains. However, for the purpose of minimizing the Cl concentration to such an extent, it is necessary to use a high-purity iron oxide raw material and to bake at a high temperature, and hence the cost is increased, and the porous ferrite particles needed in the present invention are hardly obtained.

Various Cl concentration measurement methods are available. Examples of such methods include a method using an X-ray fluorescence elemental analysis apparatus, as described in Japanese Patent Laid-Open No. 2006-267345. However, the Cl concentration measured with an X-ray fluorescence elemental analysis apparatus offers an effective method for measurement of not only the Cl present in the vicinity of the surface but also the Cl present in the interior of the particles free from the direct effect of the external environment. The present invention has discovered that the Cl present in the vicinity of the surface particularly gives rise to an interaction with the amine compound contained in the filled resin to adversely affect the charging property; thus, the Cl present in the interior of the particles fundamentally has nothing to do with such an interaction. Consequently, in the present invention, it is extremely important to specify and to control the concentration of the Cl present on the surface of the porous ferrite particles. Examples of such a measurement method include the elution method described below.

(Cl Concentration: Elution Method)

(1) For Measurement, 50.000 G of a Sample is Weighed accurately to within a margin of error of ±0.0002 g, and placed in a 150-ml glass bottle.

(2) In the glass bottle, 50 ml of phthalate pH standard solution (pH 4.01) is added.

(3) Successively, 1 ml of an ionic strength adjuster

(ionic strength adjuster for Chloride (ISA-CL DKK-TOA corp.)) is added in the glass bottle and the glass bottle is capped.

(4) The mixture thus obtained is stirred with a paint shaker for 10 minutes.

(5) While paying attention not to drop the carrier by applying a magnet to the bottom of the 150-ml glass bottle, the stirred mixture is filtered with a No. 5B filter paper into a vessel (50 ml) made of PP.

(6) The supernatant liquid thus obtained is subjected to a voltage measurement with a pH meter (HM-30S, DKK-TOA Co.) using Chlorine ion electrode (CL-125B, DKK-TOA Co.) and reference electrode (HS-305DS, DKK-TOA Co.).

(7) In the same manner, the solutions having different Cl concentrations (1 ppm, 10 ppm, 100 ppm and 1000 ppm, respectively) prepared for the calibration curve preparation are subject to the measurement, and from these measurement values the Cl concentration of the sample is derived.

The porous ferrite core material preferably contains at least one selected from Mn, Mg, Li, Ca, Sr, Cu and Zn. In consideration of the recent trend of the environmental load reduction including the waste regulation, it is preferable not to contain the heavy metals Cu, Zn and Ni each in a content exceeding an inevitable impurity (associated impurity) range.

The pore volume and the peak pore size of the porous ferrite core material are preferably 0.04 to 0.16 ml/g and 0.3 to 2.0 μm, respectively.

When the pore volume of the porous ferrite core material is less than 0.04 ml/g, no sufficient amount of the resin can be filled in, and hence the weight reduction cannot be attained. When the pore volume of the porous ferrite core material exceeds 0.16 ml/g, even the filling of the resin cannot maintain the strength of the carrier. The range of the pore volume of the porous ferrite core material is preferably 0.05 to 0.14 ml/g and more preferably 0.05 to 0.10 ml/g.

When the peak pore size of the porous ferrite core material is 0.3 μm or more, the asperity size of the surface of the core material is of an appropriate size, hence the contact area with the toner is increased, the triboelectric charging with the toner is conducted efficiently, and consequently the charge rise property is improved in spite of the low specific gravity. When the peak pore size of the porous ferrite core material is less than 0.3 μm, such an advantageous effect is not obtained and the carrier surface after filling becomes flat and smooth, and hence, no sufficient stress with the toner is given to the carrier that is low in specific gravity to degrade the charge rise. When the peak pore size of the porous ferrite core material exceeds 2.0 μm, the resin-dwelling area of the particles becomes large in relation to the surface area of the particles, and accordingly the aggregation between the particles tends to occur at the time of the resin filling and large proportions of aggregated particles and irregularly shaped particles are found in the carrier particles having been filled with the resin. Consequently, the stress in endurance printing disintegrates the aggregated particles to offer a cause for the charge variation. Such a porous core material that has a peak pore size exceeding 2.0 μm is irregular in the particle shape itself and poor in strength, and consequently the stress in endurance printing causes the cracking of the carrier particles themselves to offer a cause for the charge variation. The peak pore size of the porous ferrite core material preferably ranges from 0.4 to 1.5 μm.

As described above, the pore volume and the peak pore size designed to fall within the above-described ranges enable to obtain a resin-filled carrier that is free from the above-described problems and is appropriately reduced in weight.

[Pore Volume and Peak Pore Size of the Porous Ferrite Core Material]

The measurement of the pore volume and the peak pore size of the porous ferrite core material is conducted as follows. Specifically, the measurement is conducted with the mercury porosimeters, Pascal 140 and Pascal 240 (manufactured by Thermo Fisher Scientific Inc.). A dilatometer CD3P (for powder) is used, and a sample is put in a commercially available gelatin capsule with a plurality of bored holes and the capsule is placed in the dilatometer. After deaeration with Pascal 140, mercury is charged and a measurement in the lower pressure region (0 to 400 kPa) is conducted as a first run. Successively, the deaeration and another measurement in the lower pressure region (0 to 400 kPa) are conducted as a second run. After the second run, the total weight of the dilatometer, the mercury, the capsule and the sample is measured. Next, a high pressure region (0.1 MPa to 200 MPa) measurement is conducted with Pascal 240. From the amount of the intruded mercury as measured in the high pressure region measurement, the pore volume and the peak pore size of the porous ferrite core material are derived. The pore size is derived with the surface tension and the contact angle of mercury of 480 dyn/cm and 141.3°, respectively.

In the resin-filled carrier for an electrophotographic developer according to the present invention, the filling resin contains an amine compound.

The resin-filled carrier obtained by filling a resin in a porous ferrite is high in the electric resistance of the carrier to make it difficult to increase the charge amount. Accordingly, it is necessary for a charge controlling agent to be contained in the filling resin or to use a high-polarity organic group-containing resin. In these years, negative-polarity toners are mainly used, and carriers are required to be of a positive polarity; thus, amine compounds are quoted as high positive polarity materials. Amine compounds are effective materials because the amine compounds are high in positive polarity and enable to make toners be of a sufficient negative polarity.

As such amine compounds, various amine compounds may be used. Examples of such amine compounds include aminosilane coupling agents, amino-modified silicone oils and quaternary ammonium salts.

Particularly preferable among such amine compounds are aminosilane coupling agents. The reasons for this are that the aminosilane coupling agents are usable in combination with relatively various resins, are also effective in adhesion improvement between the porous ferrite and a resin when used in combination with the resin, offer an easy controllability of the charging property through control of the addition amount thereof, and are capable of making the toner be of a sufficient negative polarity even when used in a small amount because of having a strong positive charging property.

As the aminosilane coupling agent, any of a primary amine, a secondary amine and a compound including both of these may be used. Examples of such aminosilane coupling agents preferably used include: N-2(aminoethyl)-3-aminopropylmethyldimethoxysilane, N-2(aminoethyl)-3-aminopropyltrimethoxysilane, N-2(aminoethyl)-3-aminopropyltriethoxysilane, N-aminopropyltrimethoxysilane, N-aminopropyltriethoxysilane, 3-triethoxysilyl-N-(1,3-dimethyl-butylidene)propylamine, and N-phenyl-3-aminopropyltrimethoxysilane.

When an amine compound is used as mixed with a resin, the amine compound is preferably contained in a content of 2 to 50% by weight in the solid content of the filling resin. When the content of the amine compound is less than 2% by weight, no effect due to the inclusion of the amine compound is obtained, and when exceeds 50% by weight, no inclusion effects are further obtained uneconomically. When the content of the amine compound is too large, unpreferably the compatibility with the filling resin and other properties may become unsatisfactory and an inhomogeneous resin mixture tends to be obtained.

The resin-filled carrier for an electrophotographic developer according to the present invention is prepared by filling a resin in a porous ferrite core material. The filling amount of the resin is preferably 6 to 20 parts by weight, more preferably 7 to 18 parts by weight and most preferably 7 to 12 parts by weight in relation to 100 parts by weight of the porous ferrite core material. When the filling amount of the resin is less than 6 parts by weight, no sufficient weight reduction can be attained. When the filling amount of the resin exceeds 20 parts by weight, aggregated particles tend to occur at the time of filling to offer a cause for the charge variation.

The filling resin is not particularly limited, and can be appropriately selected depending on the toner to be combined therewith, the use environment and the like. Examples of the filling resin include: fluororesins, acrylic resins, epoxy resins, polyamide resins, polyamideimide resins, polyester resins, unsaturated polyester resins, urea resins, melamine resins, alkyd resins, phenolic resins, fluoroacrylic resins, acryl-styrene resins and silicone resins; and modified silicone resins obtained by modification with a resin such as an acrylic resin, a polyester resin, an epoxy resin, a polyamide resin, a polyamideimide resin, an alkyd resin, a urethane resin, or a fluororesin. In consideration of the exfoliation of the resin due to the mechanical stress during use, thermosetting resins are preferably used. Specific examples of the thermosetting resins include epoxy resins, phenolic resins, silicone resins, unsaturated polyester resins, urea resins, melamine resins, alkyd resins and resins containing these resins. Most preferable among these resins are silicone resins.

In addition to the cases where the filling resin to be a base is used with an amine compound, as described above, added thereto, the base resins may be beforehand modified with an amino group. Examples of such modified resins include amino-modified silicone resins, amino group-containing acrylic resins and amino group-containing epoxy resins. These resins may be used each alone and may also be used as mixtures with other resins. When a resin modified with amino groups or a mixture of the resin modified with amino groups and other resins is used, the amount of the amino groups in the whole resin is appropriately determined according to the charging property, the compatibility and the like of the resin.

For the purpose of controlling the electric resistance and the charge amount and the charging rate of the carrier, a conductive agent can be added in the filling resin in addition to the amine compound. The electric resistance of the conductive agent itself is low, and hence when the addition amount of the conductive agent is too large, a rapid charge leakage tends to occur. Accordingly, the addition amount of the conductive agent is 0.25 to 20.0% by weight, preferably 0.5 to 15.0% by weight and particularly preferably 1.0 to 10.0% by weight in relation to the solid content of the filling resin. Examples of the conductive agent include conductive carbon, oxides such as tin oxide, and various organic conductive agents.

Additionally, a charge controlling agent can be contained in the filling resin in addition to the amine compound. Examples of the charge controlling agent include various types of charge controlling agents generally used for toners and various silane coupling agents.

In the resin-filled carrier for an electrophotographic developer according to the present invention, the surface thereof is preferably coated with a coating resin. The carrier properties, in particular, the electric properties including the charging property are frequently affected by the materials present on the carrier surface and by the properties and conditions of the carrier surface. Accordingly, by coating the surface of the carrier with an appropriate resin, intended carrier properties can be regulated with a satisfactory accuracy.

The coating resin is not particularly limited. Examples of the coating resin include: fluororesins, acrylic resins, epoxy resins, polyamide resins, polyamideimide resins, polyester resins, unsaturated polyester resins, urea resins, melamine resins, alkyd resins, phenolic resins, fluoroacrylic resins, acryl-styrene resins and silicone resins; and modified silicone resins obtained by modification with a resin such as an acrylic resin, a polyester resin, an epoxy resin, a polyamide resin, a polyamideimide resin, an alkyd resin, a urethane resin, or a fluororesin. In consideration of the exfoliation of the resin due to the mechanical stress during use, thermosetting resins are preferably used. Specific examples of the thermosetting resins include epoxy resins, phenolic resins, silicone resins, unsaturated polyester resins, urea resins, melamine resins, alkyd resins and resins containing these resins. The coating amount of the resin is preferably 0.5 to 5.0 parts by weight in relation to 100 parts by weight of the resin-filled carrier (before resin coating).

In these coating resins, for the same purposes as described above, conductive agents or charge controlling agents may be contained. The types and the addition amounts of the conductive agents or the charge controlling agents are the same as in the case of the filling resin.

The volume average particle size of the resin-filled carrier for an electrophotographic developer according to the present invention is preferably 20 to 50 μm, and with this range the carrier adhesion is prevented and satisfactory image quality is obtained. When the volume average particle size is less than 20 μm, unpreferably such a particle size offers a cause for the carrier adhesion. When the volume average particle size exceeds 50 μm, unpreferably such a particle size offers a cause for the image quality degradation due to the degradation of the charge imparting ability.

The number average particle size of the resin-filled carrier for an electrophotographic developer according to the present invention is preferably 15 to 45 μm, and with this range the carrier adhesion is prevented and satisfactory image quality is obtained. When the number average particle size is less than 15 μm, unpreferably such a particle size offers a cause for the carrier adhesion. When the number average particle size exceeds 45 μm, unpreferably such a particle size offers a cause for the image quality degradation due to the degradation of the charge imparting ability.

(Volume Average Particle Size and Number Average Particle Size (Microtrac))

These average particle sizes are measured as follows. Specifically, the average particle size is measured with Microtrac Particle Size Analyzer (model 9320-X100) manufactured by Nikkiso Co., Ltd. Water is used as a dispersion medium. In a 100-ml beaker, 10 g of a sample and 80 ml of water are placed, and a few drops of a dispersant (sodium hexametaphosphate) are added in the beaker. Next, the mixture thus obtained is subjected to dispersion for 20 seconds with an ultrasonic homogenizer (model UH-150, manufactured by SMT Co., Ltd.) set at an output power level of 4. Thereafter, the foam formed on the surface of the dispersed mixture is removed and the dispersed mixture is placed in the measurement apparatus.

In this Microtrac, the particle size based on the volume is measured and the number average particle size is automatically derived from the measured value of the volume average particle size. In general, the relation between the volume average particle size and the number average particle size is as follows:

Volume average particle size=Σ(vi·di)/Σ(vi)

Number average particle size={Σ(vi)/di²}/{Σ(vi)/di³}

wherein di represents a representative particle size (μm) and vi represents the volume possessed by the particles having the representative particle size di.

The saturation magnetization of the resin-filled carrier for an electrophotographic developer according to the present invention is preferably 30 to 80 Am²/kg. The saturation magnetization less than 30 Am²/kg unpreferably offers a cause for the carrier adhesion. The saturation magnetization exceeding 80 Am²/kg leads to the hardening of the ears of the magnetic brush and makes it difficult to obtain satisfactory image quality.

[Saturation Magnetization]

The magnetization is measured with an integral-type B-H tracer, model BHU-60 (manufactured by Riken Denshi Co., Ltd.). An H coil for measuring magnetic field and a 4πI coil for measuring magnetization are inserted between the electromagnets. In this case, a sample is placed in the 4πI coil. By integrating each of the outputs from the H coil and the 4πI coil while the magnetic field H is being varied by varying the current of the electromagnet, a hysteresis loop is depicted on a sheet of recording paper with the H output on the X-axis and the 4πI coil output on the Y-axis. Here, the measurement is conducted under the following measurement conditions: the sample filling quantity: approximately 1 g; the sample filling cell: inner diameter: 7 mmφ±0.02 mm and height: 10 mm±0.1 mm; 4πI coil: 30 turns.

The true specific gravity of the resin-filled carrier for an electrophotographic developer according to the present invention is preferably 2.5 to 4.5. When the true specific gravity is less than 2.5, the carrier is too lightweight and hence the charge imparting ability tends to be degraded. When the true specific gravity exceeds 4.5, the weight reduction of the carrier is not sufficient and the durability of the carrier becomes poor.

[True Specific Gravity]

The true specific gravity is measured as follows. Specifically, the measurement is conducted in conformity with JIS R9301-2-1 by using a pycnometer. Ethanol is used as a solvent, and the measurement is conducted at a temperature of 25° C.

The apparent density of the resin-filled carrier for an electrophotographic developer according to the present invention is preferably 1.0 to 2.2 g/cm³. When the apparent density is less than 1.0 g/cm³, the carrier is too lightweight and hence the charge imparting ability tends to be degraded. When the apparent density exceeds 2.2 g/cm³, the weight reduction of the carrier is not sufficient and the durability of the carrier becomes poor.

[Apparent Density]

The apparent density is measured in conformity with JIS-Z2504 (apparent density test method of metallic powders).

In the resin-filled carrier for an electrophotographic developer according to the present invention, the content of the particles of less than 22 μm is preferably 5% by volume or less. When the content of the particles of less than 22 μm is 5% by volume or more, unpreferably the carrier adhesion tends to occur. The particles of less than 22 μm are measured with above-described Microtrac Particle Size Analyzer.

In the resin-filled carrier for an electrophotographic developer according to the present invention, the most preferred embodiment is as follows: the porous ferrite core material is a Mn—Mg—Sr ferrite, the pore volume is 0.05 to 0.10 ml/g, the peak pore size is 0.4 to 1.5 μm, the Cl concentration is 10 to 280 ppm, the filling amount of the resin is 7 to 12 parts by weight in relation to 100 parts by weight of the porous ferrite core material, the volume average particle size is 30 to 40 μm, the number average particle size is 30 to 40 μm, the saturation magnetization is 50 to 70 Am²/kg, the true specific gravity is 3.5 to 4.5, the apparent density is 1.5 to 2.0 g/cm³ and the content of the particles of less than 22 μm is 3% by volume or less.

<Production Method of the Resin-Filled Carrier for an Electrophotographic Developer According to the Present Invention>

A production method of the resin-filled carrier for an electrophotographic developer according to the present invention is described.

In the production method of the resin-filled carrier for an electrophotographic developer according to the present invention, for the purpose of producing a porous ferrite core material, first, raw materials are weighed out in appropriate amounts, and then pulverized and mixed with a ball mill, a vibration mill or the like for 0.5 hour or more, preferably, 1 to 20 hours. The raw materials are not particularly limited, but are preferably selected so as to give the composition containing the above-described elements.

The pulverized mixture thus obtained is converted into a pellet with a compression molding machine or the like, and then the pellet is calcined at a temperature of 700 to 1200° C. Without using a compression molding machine, after pulverization, the pulverized mixture may be converted into a slurry by adding water thereto, and the slurry may be converted into particles by using a spray dryer. After the calcination, further pulverization is conducted with a ball mill, a vibration mill or the like, thereafter water and, where necessary, a dispersant, a binder and the like are added, the viscosity is adjusted, and then particles are prepared with a spray dryer for granulation. In the pulverization after the calcination, pulverization may also be conducted by adding water with a wet ball mill, a wet vibration mill or the like.

The above-described pulverizing machine such as the ball mill or the vibration mill is not particularly limited; however, for the purpose of effectively and uniformly dispersing the raw materials, it is preferable to adopt fine beads having a particle size of 1 mm or less as the media to be used. By regulating the size and the composition of the beads used and the pulverization time, the degree of pulverization can be controlled.

Thereafter, the granulated substance thus obtained is maintained and sintered in an oxygen concentration-controlled atmosphere at a temperature of 800 to 1500° C. for 1 to 24 hours. In this case, a rotary electric furnace, a batch electric furnace, a continuous electric furnace or the like is used, and the atmosphere at the time of sintering may be controlled with respect to the oxygen concentration by introducing an inert gas such as nitrogen or a reductive gas such as hydrogen or carbon monoxide.

The sintered substance thus obtained is pulverized and classified. As the classification method, the existing methods such as a pneumatic classification method, a mesh filtration method and a precipitation method are used to regulate the particle size to an intended particle size.

Thereafter, where necessary, by applying low temperature heating to the surface, an oxide coat treatment is conducted and thus electric resistance can be regulated. In the oxide coat treatment, a common rotary electric furnace, a common batch electric furnace or the like is used to allow the heat treatment to be conducted, for example, at 300 to 700° C. The thickness of the oxide coat formed by this treatment is preferably 0.1 nm to 5 μm. When the thickness is less than 0.1 nm, the effect of the oxide coat layer is small, and when the thickness exceeds 5 μm, the magnetization is degraded or the resistance becomes too high, and thus unpreferably intended properties are hardly obtained. Where necessary, reduction may be conducted before the oxide coat treatment. In this way, the porous ferrite core material according to the present invention is prepared.

Examples of the method for regulating the Cl concentration of the porous ferrite core material include various methods. One of the examples is as follows: a raw material originally low in the Cl concentration is used; sufficient heating is conducted in the calcination step and/or the sintering step; and in these steps, for the purpose of efficiently removing Cl, some gasses (air, nitrogen, and others) are introduced into the furnace so as to form a gas flow within the furnace and Cl is discharged to outside the furnace together with these gasses. Where necessary, a plurality of heating steps are conducted. This is the case, for example, in a method in which for the purpose of forming a porous ferrite, sintering is conducted at a low temperature of 1200° C. or lower in the sintering step, and thereafter, heating is conducted again in order to remove Cl. In this case, at the time of reheating, heating is conducted at a temperature sufficiently lower than the temperature at the time of sintering, for example, at about 900° C. In this way, while the porous condition is being maintained, exclusively the Cl present in the vicinity of the surface of the ferrite particles can be removed.

A resin is filled in the thus obtained porous ferrite core material. As the filling method, various methods are available. Examples of the filling method include: a dry method, a spray drying method based on a fluidized bed, a rotary drying method and a dipping-and-drying method using a universal stirrer or the like. The resins to be used herein are as described above.

When a conductive agent is contained in the resin, it is preferable to effect an appropriate dispersion. As the method for that purpose, common methods can be used; examples of such methods include the methods in which used are, for example, a disperser using ultrasonic waves, a stirrer capable of imparting strong shear force and a three-roll stirrer.

By adding, where necessary, various dispersants and various surfactants, the dispersibility can be more enhanced. As the dispersant and the surfactant, common ones are used, and the above-described ones and the ones described in the below-described toner production examples are quoted.

In the step of filling the resin, it is preferable to fill the resin in the pores of the porous ferrite core material while the porous ferrite core material and the filling resin are being mixed under stirring under reduced pressure. Such filing of the resin under reduced pressure enables to efficiently fill the resin in the pores. The degree of the pressure reduction is preferably such that the pressure falls in the range from 10 to 700 mmHg. When the pressure exceeds 700 mmHg, no effect of the pressure reduction is attained, and when the pressure is less than 10 mmHg, the resin solution tends to boil during the filling step so as to inhibit efficient filling. Additionally, for the purpose of filling the amine compound, contained in the resin, in the interior of the porous substance, the above-described range is preferable.

The step of filling the resin is preferably conducted as a plurality of steps. It is possible to fill the resin in one step. Thus, it is not necessary to dare to divide the filling step into a plurality of steps. However, depending on the type of the resin, an attempt to fill a large amount of the resin at a time leads to the occurrence of the aggregation of particles as the case may be. When the carrier is used in a developing device, such aggregation of particles undergoes disintegration due to the stirring stress in the developing device as the case may be. The interface in the aggregated particles is largely different in the charging property, and hence unpreferably the charge variation occurs during passage of time. In such a case, the filling step divided into a plurality of steps enables to conduct the filling in a just enough manner while the aggregation is being prevented.

After the filling of the resin, where necessary, heating is conducted with various methods, so as to make the filled resin adhere to the core material. The heating method may be either an external heating method or an internal heating method; for example, a fixed electric furnace, a flowing electric furnace, a rotary electric furnace or a burner furnace may be used, or baking with microwave may also be adopted. The heating temperature is varied depending on the filing resin; the heating temperature is required to be a temperature equal to or higher than the melting point or the glass transition point; when a thermosetting resin, a condensation-crosslinking resin or the like is used, by increasing the heating temperature to a temperature allowing the curing to proceed, a resin-filled carrier that has resistance against impact can be obtained.

After the resin has been filled in the porous ferrite core material as described above, the surface of the core material is preferably coated with a resin. The carrier properties, in particular, the electric properties including the charging property are frequently affected by the materials present on the carrier surface and by the properties and conditions of the carrier surface. Accordingly, by coating the surface of the core material with an appropriate resin, intended carrier properties can be regulated with a satisfactory accuracy. As the method for coating, heretofore known methods such as a brush coating method, a dry method, a spray drying method based on a fluidized bed, a rotary drying method and a dipping-and-drying method using a universal stirrer can be applied for coating. For the purpose of improving the coverage factor, the method based on a fluidized bed is preferable. When baking is conducted after the resin coating, either an external heating method or an internal heating method may be used; for example, a fixed electric furnace, a flowing electric furnace, a rotary electric furnace or a burner furnace may be used, or baking with microwave may also be adopted. When a UV curable resin is used, a UV heater is used. The baking temperature is varied depending on the resin used; the baking temperature is required to be a temperature equal to or higher than the melting point or the glass transition point; when a thermosetting resin, a condensation-crosslinking resin or the like is used, the baking temperature is required to be increased to a temperature allowing the curing to proceed sufficiently.

### <Electrophotographic Developer According to the Present Invention>

Next, the electrophotographic developer according to the present invention is described.

The electrophotographic developer according to the present invention is composed of the above-described resin-filled carrier for an electrophotographic developer and a toner.

Examples of the toner particle that constitutes the electrophotographic developer of the present invention include a pulverized toner particle produced by a pulverization method and a polymerized toner particle produced by a polymerization method. In the present invention, the toner particle obtained by either of these methods can be used.

The pulverized toner particle can be obtained, for example, by means of a method in which a binder resin, a charge controlling agent and a colorant are fully mixed together with a mixing machine such as a Henschel mixer, then the mixture thus obtained is melt-kneaded with an apparatus such as a double screw extruder, and the melt-kneaded substance is cooled, pulverized and classified, added with an external additive, and thereafter mixed with a mixing machine such as a mixer to yield the pulverized toner particle.

The binder resin that constitutes the pulverized toner particle is not particularly limited. However, examples of the binder resin may include polystyrene, chloropolystyrene, styrene-chlorostyrene copolymer, styrene-acrylate copolymer and styrene-methacrylic acid copolymer, and further, rosin-modified maleic acid resin, epoxy resin, polyester resin and polyurethane resin. These binder resins are used each alone or as mixtures thereof.

As the charge controlling agent, any charge controlling agent can be used. Examples of the charge controlling agent for use in positively charged toners may include nigrosine dyes and quaternary ammonium salts. Additionally, examples of the charge controlling agent for use in negatively charged toners may include metal-containing monoazo dyes.

As the colorant (coloring material), hitherto known dyes and pigments can be used. Examples of the usable colorant include carbon black, phthalocyanine blue, permanent red, chrome yellow and phthalocyanine green. Additionally, for the purpose of improving the fluidity and the anti-aggregation property of the toner, external additives such as a silica powder and titania can be added to the toner particle according to the toner particle.

The polymerized toner particle is a toner particle produced by heretofore known methods such as a suspension polymerization method, an emulsion polymerization method, an emulsion aggregation method, an ester extension polymerization method and a phase inversion emulsion method. Such a polymerized toner particle can be obtained, for example, as follows: a colorant dispersion liquid in which a colorant is dispersed in water with a surfactant, a polymerizable monomer, a surfactant and a polymerization initiator are mixed together in a aqueous medium under stirring to disperse the polymerizable monomer by emulsification in the aqueous medium; the polymerizable monomer thus dispersed is polymerized under stirring for mixing; thereafter, the polymer particles are salted out by adding a salting-out agent; the particles obtained by salting-out is filtered off, rinsed and dried, and thus the polymerized toner particle can be obtained. Thereafter, where necessary, an external additive is added to the dried toner particle.

Further, when the polymerized toner particle is produced, in addition to the polymerizable monomer, the surfactant, the polymerization initiator and the colorant, a fixability improving agent and a charge controlling agent can also be mixed; the various properties of the obtained polymerized toner particle can be controlled and improved by these agents. Additionally, a chain transfer agent can also be used for the purpose of improving the dispersibility of the polymerizable monomer in the aqueous medium and regulating the molecular weight of the obtained polymer.

The polymerizable monomer used in the production of the polymerized toner particle is not particularly limited. However, example of such a polymerizable monomer may include: styrene and the derivatives thereof; ethylenically unsaturated monoolefins such as ethylene and propylene; vinyl halides such as vinyl chloride; vinyl esters such as vinyl acetate; and α-methylene aliphatic monocarboxylic acid esters such as methyl acrylate, ethyl acrylate, methyl methacrylate, ethyl methacrylate, 2-ethylhexyl methacrylate, acrylic acid dimethylamino ester and methacrylic acid diethylamino ester.

As the colorant (coloring material) used when the polymerized toner particle is prepared, hitherto known dyes and pigments can be used. Examples of the usable colorant include carbon black, phthalocyanine blue, permanent red, chrome yellow and phthalocyanine green. Additionally, the surface of each of these colorants may be modified by using a silane coupling agent, a titanium coupling agent or the like.

As the surfactant used in the production of the polymerized toner particle, anionic surfactants, cationic surfactants, amphoteric surfactants and nonionic surfactants can be used.

Here, examples of the anionic surfactants may include: fatty acid salts such as sodium oleate and castor oil; alkyl sulfates such as sodium lauryl sulfate and ammonium lauryl sulfate; alkylbenzenesulfonates such as sodium dodecylbenzenesulfonate; alkylnaphthalenesulfonates; alkylphosphoric acid ester salts; naphthalenesulfonic acid-formalin condensate; and polyoxyethylene alkyl sulfuric acid ester salts. Additionally, examples of the nonionic surfactants may include: polyoxyethylene alkyl ethers, polyoxyethylene fatty acid esters, sorbitan fatty acid esters, polyoxyethylene alkylamines, glycerin, fatty acid esters and oxyethylene-oxypropylene block polymer. Further, examples of the cationic surfactants may include: alkylamine salts such as laurylamine acetate; and quaternary ammonium salts such as lauryltrimethylammonium chloride and stearyltrimethylammonium chloride. Additionally, examples of the amphoteric surfactants may include aminocarboxylic acid salts and alkylamino acids.

The above-described surfactants can each be used usually in a range from 0.01 to 10% by weight in relation to the polymerizable monomer. The used amount of such a surfactant affects the dispersion stability of the monomer, and also affects the environment dependence of the obtained polymerized toner particle, and hence such a surfactant is preferably used within the above-described range in which the dispersion stability of the monomer is ensured and the environment dependence of the polymerized toner particle is hardly affected in an excessive manner.

For the production of the polymerized toner particle, usually a polymerization initiator is used. Examples of the polymerization initiator include water-soluble polymerization initiators and oil-soluble polymerization initiators. In the present invention, either of a water-soluble polymerization initiator and an oil-soluble polymerization initiator can be used. Examples of the water-soluble polymerization initiator usable in the present invention may include: persulfates such as potassium persulfate and ammonium persulfate; and water-soluble peroxide compounds. Additionally, examples of the oil-soluble polymerization initiator usable in the present invention may include: azo compounds such as azobisisobutyronitrile; and oil-soluble peroxide compounds.

Additionally, for a case where a chain transfer agent is used in the present invention, examples of the chain transfer agent may include: mercaptans such as octylmercaptan, dodecylmercaptan and tert-dodecylmercaptan; and carbon tetrabromide.

Further, for a case where the polymerized toner particle used in the present invention contains a fixability improving agent, examples of the usable fixability improving agent include: natural waxes such as carnauba wax; and olefin waxes such as polypropylene wax and polyethylene wax.

Additionally, for a case where the polymerized toner particle used in the present invention contains a charge controlling agent, the charge controlling agent used is not particularly limited, and examples of the usable charge controlling agent include nigrosine dyes, quaternary ammonium salts, organometallic complexes and metal-containing monoazo dyes.

Additionally, examples of the external additives used for improving the fluidity and the like of the polymerized toner particle may include silica, titanium oxide, barium titanate, fluororesin fine particles and acrylic resin fine particles. These external additives can be used each alone or in combinations thereof.

Further, examples of the salting-out agent used for separation of the polymerized particles from the aqueous medium may include metal salts such as magnesium sulfate, aluminum sulfate, barium chloride, magnesium chloride, calcium chloride and sodium chloride.

The average particle size of the toner particle produced as described above falls in a range from 2 to 15 μm and preferably in a range from 3 to 10 μm, and the polymerized toner particle is higher in the particle uniformity than the pulverized toner particle. When the average particle size of the toner particle is smaller than 2 μm, the charging ability is degraded to tend to cause fogging or toner scattering; when larger than 15 μm, such a particle size offers a cause for image quality degradation.

Mixing of the carrier and the toner produced as described above can yield an electrophotographic developer. The mixing ratio between the carrier and the toner, namely, the toner concentration is preferably set at 3 to 15% by weight. When the toner concentration is less than 3% by weight, it is difficult to attain a desired image density; when larger than 15% by weight, toner scattering or fogging tends to occur.

The developer obtained by mixing the carrier produced as described above and a toner can be used as a refill developer. In this case, the carrier and the toner are mixed together in a mixing ratio of 1 part by weight of the carrier to 2 to 50 parts by weight of the toner.

The electrophotographic developer according to the present invention, prepared as described above, can be used in a digital image formation apparatus, such as a copying machine, a printer, a FAX machine or a printing machine, adopting a development method in which an electrostatic latent image formed on a latent image holder having an organic photoconductor layer is reversely developed, while applying a bias electric field, with a magnetic brush of a two-component developer having a toner and a carrier. Additionally, the electrophotographic developer according to the present invention is also applicable to an image formation apparatus, such as a full-color machine, which adopts a method applying an alternating electric field composed of a DC bias and an AC bias superposed on the DC bias when a development bias is applied from the magnetic brush to the electrostatic latent image.

Hereinafter, the present invention is specifically described on the basis of Examples and others; however, the present invention is not limited by what is described.

### Core Material Production Example 1

Raw materials were weighed out so as to give the following composition: MnO: 35 mol %, MgO: 14.5 mol %, Fe₂O₃: 50 mol %, and SrO: 0.5 mol %. The weighed out raw materials were pulverized with a dry media mill (vibration mill, stainless steel beads of ⅛ inch in diameter) for 5 hours, and the pulverized substance thus obtained was converted into about 1-mm cube pellets with a roller compactor. As the raw materials for MnO, MgO and SrO, trimanganese tetraoxide, magnesium hydroxide and strontium carbonate were used, respectively. The content of the Cl contained in Fe₂O₃ as an impurity was found to be 0.12% by weight (1200 ppm; as measured by X-ray fluorescence elemental analysis method, namely, XRF measurement). In the above-described composition, the content of Fe₂O₃ is about 72% in terms of weight ratio, and hence the Cl originated from Fe₂O₃ can be estimated to be contained in the pellets in a content of about 860 ppm.

The pellets were subjected to coarse powder removal with a vibration sieve of 3 mm in mesh opening size, and then subjected to removal of fine powder with a vibration sieve of 0.5 mm in mesh opening size. Thereafter, the pellets were heated for calcination at 1050° C. for 3 hours with a rotary electric furnace. Then, the pellets were pulverized to an average particle size of 4.1 μm with a dry media mill (vibration mill, stainless steel beads of ⅛ inch in diameter). Then, water was added to the pulverized pellets, and the mixture thus obtained was further pulverized for 5 hours with a wet media mill (upright bead mill, stainless steel beads of 1/16 inch in diameter). The particle size (primary particle size of the pulverized substance) of the slurry thus obtained was measured with Microtrac, and the D₅₀ was found to be 1.8 μm. An appropriate amount of a dispersant was added to the slurry, and for the purpose of obtaining an appropriate pore volume, PVA (20% solution) as a binder was added to the slurry in an amount of 0.4% by weight in relation to the solid content of the slurry. Then, the thus treated slurry was granulated and dried with a spray dryer. The obtained particles (granulated substance) were regulated in particle size, and then heated at 700° C. for 2 hours with a rotary electric furnace to remove the dispersant and the organic components such as the binder.

Thereafter, the particles were maintained at a sintering temperature of 1125° C. for 5 hours in an atmosphere of nitrogen gas with a tunnel electric furnace. In this case, the temperature increase rate was set at 150° C./hr and the cooling rate was set at 110° C./hr. For the purpose of reducing the Cl concentration in the porous ferrite particles, nitrogen gas was introduced from the exit of the tunnel furnace at a rate of 80 L/min. In this connection, the internal pressure of the tunnel furnace was set at 0 to 10 Pa (positive pressure), so that the chlorine generated at the time of the sintering was efficiently discharged from the tunnel furnace. Thereafter, the particles were disintegrated, further classified to regulate the particle size, and subjected to separation of low magnetic fractions with magnetic separation to yield porous ferrite particles (a core material).

### Core Material Production Example 2

For the purpose of removing the chlorine generated at the time of the calcination, air was introduced from the outside into the interior of the rotary electric furnace at the time of the calcination. Additionally, the sintering temperature was set at 1100° C. Otherwise in the same manner as in the core material production example 1, porous ferrite particles (a core material) were obtained.

### Core Material Production Example 3

The sintering temperature in the tunnel electric furnace was altered to 1100° C. Otherwise in the same manner as in the core material production example 1, porous ferrite particles (a core material) were obtained.

### Core Material Production Example 4

As the raw material iron oxide, Fe₂O₃ having a Cl content of 0.20% by weight (2000 ppm) was used. Additionally, the sintering temperature was set at 1130° C. Otherwise in the same manner as in the core material production example 1, porous ferrite particles (a core material) were obtained.

### Core Material Production Example 5

As the raw material iron oxide, Fe₂O₃ having a Cl content of 0.20% by weight (2000 ppm) was used. The calcination temperature was set at 400° C., and the sintering temperature was set at 1190° C. Additionally, the introduction rate of the nitrogen gas introduced into the interior of the tunnel furnace was set at 1 L/min. Otherwise in the same manner as in the core material production example 1, porous ferrite particles (a core material) were obtained.

### Core Material Production Example 6

The sintering temperature was set at 1170° C. Otherwise in the same manner as in the core material production example 5, porous ferrite particles (a core material) were obtained.

### Core Material Production Example 7

The calcination temperature was set at 1100° C. After the granulation with the spray dryer, heating was conducted at 700° C. for 2 hours with a rotary electric furnace to remove the dispersant and the organic components such as the binder. Thereafter, with the rotary electric furnace, heating was further conducted at 1070° C. for 2 hours and then sintering was conducted at 1280° C. Otherwise in the same manner as in the core material production example 1, ferrite particles (a core material) were obtained.

Table 1 shows the properties (pore volume, peak pore size, volume average particle size, apparent density, ratio of Cl/Fe (XRF measurement) and Cl concentration (elution method)) of the ferrite particles obtained in the core material production examples 1 to 7. The ratios of Cl/Fe (XRF measurement) were measured as described below. The measurement methods of the other properties are as described above.

### (X-Ray Fluorescence Elemental Analysis: XRF Measurement)

As the measurement apparatus, an X-ray fluorescence spectrometer (ZSX 100s, manufactured by Rigaku Corp.) was used. About 5 g of a sample was placed in a vacuum powder sample container, the container was set in the sample holder, and the measurement of Cl and Fe was conducted with the above-described apparatus.

Herein the measurement conditions were as follows. For Cl, the Cl—Kα ray was adopted as the measurement ray, the X-ray tube voltage and current were set at 50 kV and 50 mA, respectively, a Ge crystal was used as the analyzing crystal and a PC (proportional counter) was used as the detector. For Fe, the Fe—Kα ray was adopted as the measurement ray, the X-ray tube voltage and current were set at 50 kV and 50 mA, respectively, a LiF crystal was used as the analyzing crystal and a SC (scintillation counter) was used as the detector.

The respective X-ray fluorescence intensities thus obtained were used to derive the ratio of Cl/Fe (Cl intensity/Fe intensity).

TABLE 1

| | | Properties of porous ferrite | | | | | |
|---|---|---|---|---|---|---|---|
| | Core | Pore | Peak pore | Volume average | Apparent | Ratio of | Cl concentration: |
| | material | volume | size | particle size | density | Cl/Fe: XRF | elution method |
| | No. | (ml/g) | (μm) | (μm) | (g/cm³) | measurement | (ppm) |
| Core | 1 | 0.0628 | 1.32 | 36.0 | 1.64 | 2.76 × 10⁴ | 183 |
| material | | | | | | | |
| production | | | | | | | |
| example 1 | | | | | | | |
| Core | 2 | 0.1181 | 1.37 | 35.9 | 1.28 | 4.07 × 10⁴ | 194 |
| material | | | | | | | |
| production | | | | | | | |
| example 2 | | | | | | | |
| Core | 3 | 0.1123 | 1.27 | 36.5 | 1.28 | 5.29 × 10⁴ | 244 |
| material | | | | | | | |
| production | | | | | | | |
| example 3 | | | | | | | |
| Core | 4 | 0.0946 | 1.05 | 37.2 | 1.59 | 5.10 × 10⁴ | 280 |
| material | | | | | | | |
| production | | | | | | | |
| example 4 | | | | | | | |
| Core | 5 | 0.0491 | 1.00 | 36.7 | 1.75 | 6.30 × 10⁴ | 313 |
| material | | | | | | | |
| production | | | | | | | |
| example 5 | | | | | | | |
| Core | 6 | 0.0605 | 1.01 | 36.7 | 1.64 | 5.61 × 10⁴ | 325 |
| material | | | | | | | |
| production | | | | | | | |
| example 6 | | | | | | | |
| Core | 7 | 0.0094 | Not | 35.3 | 2.18 | 3.17 × 10⁴ | 78 |
| material | | | measurable | | | | |
| production | | | | | | | |
| example 7 | | | | | | | |

As can be seen from Table 1, the Cl concentration is varied depending on the Cl concentration in the raw material and the conditions of the respective heating steps. In the core material production example 7, the pore volume is as low as 0.0094 ml/g, indicating that there is no porosity as comparable to the porosities found in the core material production examples 1 to 6. Accordingly, in the core material production example 7, the pore size measurement gave a pore size distribution without any peak, to fail in measuring the peak pore size. In other words, the ferrite particles obtained in the core material production example 7 did not lead to a porous ferrite core material.

### Example 1

Next, 100 parts by weight of the porous ferrite particles obtained in the core material production example 1 and a condensation-crosslinked silicone resin (weight average molecular weight: about 8000) mainly composed of the T unit and the D unit were prepared. To 40 parts by weight of a solution of the silicone resin (the resin solution concentration was 20%, hence 8 parts by weight in terms of the solid content; dilution solvent: toluene), an aminosilane coupling agent (3-aminopropyltrimethoxysilane) was added as an amine compound so as to have a concentration of 10% by weight in relation to the resin solid content. While the mixture thus obtained was being mixed under stirring at 60° C. under a reduced pressure of 2.3 kPa and the toluene was being evaporated, the resin was impregnated and filled in the interior of the porous ferrite core material.

After making sure of the sufficient evaporation of the toluene, the mixture was further continuously stirred for 30 minutes to remove the toluene almost completely. Thereafter, the mixture was take out from the filling apparatus and transferred into a vessel, and the vessel was placed in a hot air heating oven to conduct a heat treatment at 220° C. for 2 hours.

Thereafter, cooling down to room temperature was conducted and the ferrite particles with the cured resin therein were taken out, subjected to disintegration of the particle aggregation with a vibration sieve of 200M in mesh opening size and subjected to removal of nonmagnetic substances with a magnetic separator. Thereafter, coarse particles were removed again with a vibration sieve to yield particles filled with a resin, namely, resin-filled particles (resin-filled carrier).

### Example 2

The porous ferrite particles obtained in the core material production example 2 were used, and the filling amount of the silicone resin was set at 15 parts by weight in terms of the solid content. Otherwise in the same manner as in Example 1, resin-filled particles (resin-filled carrier) were obtained.

### Example 3

The porous ferrite particles obtained in the core material production example 3 were used, and the filling amount of the silicone resin was set at 13 parts by weight in terms of the solid content, and N-2(aminoethyl)-3-aminopropyltrimethoxysilane was added as an aminosilane coupling agent so as to have a concentration of 10% by weight in relation to the resin solid content. Otherwise in the same manner as in Example 1, resin-filled particles (resin-filled carrier) were obtained.

### Example 4

The porous ferrite particles obtained in the core material production example 3 were used, and N-2(aminoethyl)-3-aminopropyltrimethoxysilane was added as an aminosilane coupling agent so as to have a concentration of 5% by weight in relation to the resin solid content. Otherwise in the same manner as in Example 3, resin-filled particles (resin-filled carrier) were obtained.

### Example 5

The porous ferrite particles obtained in the core material production example 3 were used, and the filling amount of the silicone resin was set at 15 parts by weight in terms of the solid content. Otherwise in the same manner as in Example 4, resin-filled particles (resin-filled carrier) were obtained.

### Example 6

The porous ferrite particles obtained in the core material production example 4 were used, and the filling amount of the silicone resin was set at 11 parts by weight in terms of the solid content. Otherwise in the same manner as in Example 1, resin-filled particles (resin-filled carrier) were obtained.

### Comparative Example 1

The porous ferrite particles obtained in the core material production example 5 were used. Otherwise in the same manner as in Example 1, resin-filled particles (resin-filled carrier) were obtained.

### Comparative Example 2

The porous ferrite particles obtained in the core material production example 6 were used. Otherwise in the same manner as in Example 1, resin-filled particles (resin-filled carrier) were obtained.

### Comparative Example 3

The ferrite particles obtained in the core material production example 7 were used, the amount of the silicone resin was set at 2 parts by weight in terms of the solid content, and N-2(aminoethyl)-3-aminopropyltrimethoxysilane was added as an aminosilane coupling agent so as to have a concentration of 10% by weight in relation to the resin solid content. Otherwise in the same manner as in Example 1, a carrier was obtained. In this case, the ferrite obtained in the core material production example 7 is not porous, and hence the obtained carrier is a so-called resin-coated ferrite carrier in which the resin is present for the most part on the surface of the core material.

### Comparative Example 4

The ferrite particles obtained in the core material production example 7 were used and the amount of the silicone resin was set at 0.5 part by weight. Otherwise in the same manner as in Comparative Example 3, a resin-coated ferrite carrier was obtained.

Table 2 shows the types of the ferrite particles and the types and the amounts of the filling resins and the amine compounds used in the Examples 1 to 6 and Comparative Examples 1 to 4. Table 3 shows the properties (volume average particle size, content of particles of less than 22 μm, number average particle size, saturation magnetization, apparent density, true specific gravity, charge amounts under various environments and ratios therebetween) of the resin-filled particles (resin-filled carriers) obtained in Examples 1 to 6 and Comparative Examples 1 and 2 and the resin-coated ferrite carriers obtained in Comparative Examples 3 and 4. The charge amounts were measured as follows. The measurement methods of the other properties are as described above.

(Charge Amount)

A developer was prepared by mixing together a carrier and a commercially available negatively polar toner (cyan toner for use in DocuPrintC3530, manufactured by Fuji Xerox Co., Ltd.) used in a full-color printer so as for the toner concentration to be 5% by weight (the weight of the toner=2.5 g, the weight of the carrier=48.5 g). The thus prepared developer was placed in a 50-cc glass bottle and stirred for 30 minutes at a rotation number of 100 rpm, and the charge amount was obtained from the measurement with a suction-type charge amount measurement apparatus (Epping q/m-meter, manufactured by PES-Laboratorium).

Herein, the conditions in the following different environments are as follows.

Normal temperature and normal humidity (NN): Temperature: 23° C., relative humidity: 55%

High temperature and high humidity (HH): Temperature: 30° C., relative humidity: 80%

Low temperature and low humidity (LL): Temperature: 10° C., relative humidity: 15%

TABLE 2

| | | Filling resin | | Amine compound | |
|---|---|---|---|---|---|
| | Core | | Parts | | % by weight |
| | material | | by | | (in relation to the |
| | No. | Type | weight | Type* | resin solid content) |
| Example 1 | 1 | Silicone | 8 | A | 10 |
| | | resin | | | |
| Example 2 | 2 | Silicone | 15 | A | 10 |
| | | resin | | | |
| Example 3 | 3 | Silicone | 13 | B | 10 |
| | | resin | | | |
| Example 4 | 3 | Silicone | 13 | B | 5 |
| | | resin | | | |
| Example 5 | 3 | Silicone | 15 | B | 5 |
| | | resin | | | |
| Example 6 | 4 | Silicone | 11 | A | 10 |
| | | resin | | | |
| Comparative | 5 | Silicone | 8 | A | 10 |
| Example 1 | | resin | | | |
| Comparative | 6 | Silicone | 8 | A | 10 |
| Example 2 | | resin | | | |
| Comparative | 7 | Silicone | 2 | B | 10 |
| Example 3 | | resin | | | |
| Comparative | 7 | Silicone | 0.5 | B | 10 |
| Example 4 | | resin | | | |

*Type of amine compound
A: 3-Aminopropyltrimethoxysilane
B: N-2(aminoethyl)-3-aminopropyltrimethoxysilane

TABLE 3

| | | | Content of | | | | |
|---|---|---|---|---|---|---|---|
| | Core | Volume average | particles of less | Number average | Saturation | Apparent | True |
| | material | particle size | than 22 μm | particle size | magnetization | density | specific |
| | No. | (μm) | (% by volume) | (μm) | (Am²/kg) | (g/cm³) | gravity |
| Example 1 | 1 | 36.1 | 1.3 | 34.0 | 68 | 1.11 | 4.13 |
| Example 2 | 2 | 36.9 | 1.7 | 33.1 | 62 | 1.52 | 3.55 |
| Example 3 | 3 | 36.6 | 1.7 | 32.9 | 64 | 1.56 | 3.68 |
| Example 4 | 3 | 38.3 | 1.0 | 34.7 | 65 | 1.54 | 3.77 |
| Example 5 | 3 | 35.5 | 1.2 | 32.8 | 63 | 1.48 | 3.59 |
| Example 6 | 4 | 36.5 | 1.5 | 34.5 | 65 | 1.65 | 3.84 |
| Comparative | 5 | 37.9 | 0.5 | 34.7 | 67 | 1.78 | 4.11 |
| Example 1 | | | | | | | |
| Comparative | 6 | 37.3 | 0.5 | 34.4 | 68 | 1.90 | 4.10 |
| Example 2 | | | | | | | |
| Comparative | 7 | 38.9 | 2.5 | 35.2 | 69 | 1.98 | 4.85 |
| Example 3 | | | | | | | |
| Comparative | 7 | 37.1 | 2.5 | 33.6 | 69 | 2.11 | 4.85 |
| Example 4 | | | | | | | |

| | Charge amount | Charge amount | Charge amount | | | |
|---|---|---|---|---|---|---|
| | (μC/g), H/H | (μC/g), N/N | (μC/g), L/L | Charge amount | Charge amount | Charge amount |
| | environment | environment | environment | ratio, LL/NN | ratio, LL/HH | ratio, NN/HH |
| Example 1 | 19.8 | 21.2 | 21.6 | 1.02 | 1.09 | 1.07 |
| Example 2 | 20.3 | 23.4 | 25.4 | 1.09 | 1.25 | 1.15 |
| Example 3 | 23.8 | 24.8 | 30.4 | 1.23 | 1.28 | 1.04 |
| Example 4 | 19.8 | 21.0 | 24.0 | 1.14 | 1.21 | 1.06 |
| Example 5 | 21.2 | 22.2 | 27.6 | 1.24 | 1.30 | 1.05 |
| Example 6 | 20.8 | 22.3 | 23.5 | 1.05 | 1.13 | 1.07 |
| Comparative | 6.1 | 9.8 | 13.4 | 1.37 | 2.20 | 1.61 |
| Example 1 | | | | | | |
| Comparative | 5.4 | 9.2 | 14.6 | 1.59 | 2.70 | 1.70 |
| Example 2 | | | | | | |
| Comparative | 8.0 | 8.9 | 12.1 | 1.36 | 1.51 | 1.11 |
| Example 3 | | | | | | |
| Comparative | 22.1 | 24.0 | 24.0 | 1.00 | 1.09 | 1.09 |
| Example 4 | | | | | | |

(Evaluations)

As can be seen from the results shown in Table 3, in each of the resin-filled carriers shown in Examples 1 to 6, a porous ferrite core material having an appropriate Cl concentration was used, and hence even when the amine compound-containing filling resin was filled in the ferrite core material, an appropriate charge amount of the order of 15 to 30 μC/g was obtained. The charge amounts measured under the different environments are free from large variation to exhibit stable charging property. Further, in each of Examples 1 to 6, a porous ferrite core material having an appropriate pore volume and an appropriate peak pore size was used, and a resin is filled in an amount appropriate to the core material, and hence an appropriate weight reduction was attained.

The above-described facts show that each of the resin-filled carriers shown in Examples 1 to 6 realized a low specific gravity and simultaneously had a satisfactory charging property. Accordingly, it is easily conceivable that when each of these carriers is actually used in a developer, the degradation of the carrier performance is small in the course of the use of these carriers, the charging property is stable even in a varying environment, and satisfactory image quality free from image defect such as toner scattering or fogging is obtained. It can be inferred that such a developer can also be suitably used as a refill developer.

On the other hand, in each of the carriers shown in Comparative Examples 1 and 2, the Cl concentration in the porous ferrite core material was large, and hence even when the amine compound was used, the charge amount was low and the environmental stability of the charge amount was remarkably poor.

Each of the carriers shown in Comparative Examples 3 and 4 is a so-called common resin-coated ferrite carrier in which a ferrite core material nonporous and extremely small in pore volume was used. Consequently, no sufficient weight reduction was attained.

As described above, it is easily inferred that when each of the carriers obtained in Comparative Examples 1 and 2 is actually used, the charge amount is low in the first place, the chare amount is largely varied by the environmental variation, and hence the image defect such as toner scattering or fogging is easily caused.

It is also easily inferred that when each of the carriers obtained in Comparative Example 3 and 4 is actually used, no sufficient weight reduction is attained, hence the carrier performance is remarkably degraded due to the stress in an actual machine, the image quality is largely varied in the course of the use as a developer, and thus no satisfactory image quality can be stably maintained.

The resin-filled carrier for an electrophotographic developer according to the present invention is a resin-filled ferrite carrier, hence permits attaining a low specific gravity and the weight reduction, accordingly is excellent in durability and permits attaining a long operating life, is excellent in fluidity, permits easy controlling of the charge amount and the like, is higher in strength than magnetic powder-dispersed carrier, and is free from the cracking, deformation and melting due to heat or impact. Additionally, the Cl concentration is controlled to fall within a certain range and the filling resin contains an amine compound, and hence an intended charge amount can be obtained and the environmental variation of the charge amount is small.

Consequently, the resin-filled carrier for an electrophotographic developer according to the present invention can be widely used in the fields associated with full-color machines required to be high in image quality and high-speed machines required to be satisfactory in the reliability and durability in the image maintenance.

1. A resin-filled carrier for an electrophotographic developer which carrier is obtained by filling a resin in the voids of a porous ferrite core material,
wherein the Cl concentration of the porous ferrite core material, measured by an elution method, is 10 to 280 ppm; and
the resin comprises an amine compound.

2. The resin-filled carrier for an electrophotographic developer according to claim 1, wherein the amine compound is an aminosilane coupling agent.

3. The resin-filled carrier for an electrophotographic developer according to claim 1, wherein the resin is a silicone resin.

4. The resin-filled carrier for an electrophotographic developer according to claim 1, wherein the pore volume and the peak pore size of the porous ferrite core material are 0.04 to 0.16 ml/g and 0.3 to 2.0 μm, respectively.

5. The resin-filled carrier for an electrophotographic developer according to claim 1, wherein the filling amount of the resin is 6 to 20 parts by weight in relation to 100 parts by weight of the porous ferrite core material.

6. The resin-filled carrier for an electrophotographic developer according to claim 1, wherein the composition of the porous ferrite core material comprises at least one selected from Mn, Mg, Li, Ca, Sr, Cu and Zn.

7. The resin-filled carrier for an electrophotographic developer according to claim 1, wherein:
the volume average particle size is 20 to 50 μm, the number average particle size is 15 to 45 μm, the saturation magnetization is 30 to 80 Am²/kg, the true specific gravity is 2.5 to 4.5, the apparent density is 1.0 to 2.2 g/cm³ and the content of the particles of less than 22 μm is 5% by volume or less.

8. The resin-filled carrier for an electrophotographic developer according to claim 1, wherein:
the porous ferrite core material is a Mn—Mg—Sr ferrite in which the pore volume is 0.05 to 0.10 ml/g, the peak pore size is 0.4 to 1.5 μm and the Cl concentration is 10 to 280 ppm;
the filling amount of the resin is 7 to 12 parts by weight in relation to 100 parts by weight of the porous ferrite core material; and
the volume average particle size is 30 to 40 μm, the number average particle size is 30 to 40 μm, the saturation magnetization is 50 to 70 Am²/kg, the true specific gravity is 3.5 to 4.5, the apparent density is 1.5 to 2.0 g/cm³ and the content of the particles of less than 22 μm is 3% by volume or less.

9. An electrophotographic developer comprising the resin-filled carrier according to claim 1 and a toner.

10. The electrophotographic developer according to claim 9, used as a refill developer.
